(19) United States
(12) Patent Application Publication
(10) Pub. No.: US 2023/0029021 A1
(43) Pub. Date: Jan. 26, 2023

(54) LIGHTING APPARATUS DRIVER

(71) Applicant: Current Lighting Solutions, LLC, East Cleveland, OH (US)

(72) Inventors: Zhu Mao, Shanghai (CN); Shuyi Qin, Shanghai (CN); Min Fang, Shanghai (CN)

(21) Appl. No.: 17/787,994

(22) PCT Filed: Jan. 9, 2020
(86) PCT No.: PCT/CN2020/071065

§ 371 Date: Jun. 22, 2022

(51) Int. Cl. H05B 45/10

(52) U.S. Cl. CPC H05B 45/10; H05B 45/375

(57) ABSTRACT

The present invention relates to a lighting apparatus driver, comprising: a filter, which is used to filter out noise; a rectifier, which is used to convert an alternating current voltage into a direct current voltage; and a plurality of voltage regulator integrated circuit (IC) modules, which are directly or indirectly connected to the rectifier, wherein each one of the plurality of voltage regulator IC modules is used to connect to a separate lighting apparatus, so that each one of the plurality of voltage regulator IC modules can independently control the electric current inputted into the lighting apparatus connected thereto.

### TECHNICAL FIELD

The present invention relates to the field of lighting, and more particularly, to a lighting apparatus driver for enabling a plurality of LEDs to maintain substantially the same brightness.

### BACKGROUND ART

Currently, light-emitting diodes (LEDs) are gradually becoming one of the mainstream lighting applications because of their various advantages, such as small size, high luminous efficiency, low energy consumption, and long service life. More and more LED light sources are replacing conventional light sources.

LED lamps are usually connected in parallel, and Boost topological modules and half bridge circuits are commonly used in many LED drivers. A driver can increase or decrease the brightness of a plurality of LED lamps simultaneously by a dimming technique (for example, PWM dimming). When a driver considerably dims a plurality of LED lamps connected in parallel, it becomes more difficult to cause each of the lamps to maintain substantially the same brightness, especially when the LED lamps operate at low temperatures. Lighting provided by LEDs of different brightness creates an unpleasant experience for users.

Therefore, there is a need for an improved lighting apparatus driver that makes the brightness of each LED lamp adjustable to become substantially the same, especially when the LED lamps are considerably dimmed.

### SUMMARY OF THE INVENTION

The present invention relates to a lighting apparatus driver, comprising: a filter to filter out noise; a rectifier to convert an alternating current voltage into a direct current voltage; and a plurality of voltage regulator integrated circuit (IC) modules connected to the rectifier directly or indirectly, wherein each of the plurality of voltage regulator IC modules is to be connected to a separate lighting apparatus, such that each of the plurality of voltage regulator IC modules is capable of independently controlling current input to the lighting apparatus connected thereto.

In the lighting apparatus driver as described above, the plurality of voltage regulator IC modules are Buck modules or FlyBack modules.

The lighting apparatus driver as described above further comprises a dimming control, and the dimming control is coupled to each of the plurality of voltage regulator IC modules, so as to send a dimming control signal to each of the plurality of voltage regulator IC modules.

With the lighting apparatus driver as described above, when the dimming control signal is to cause brightness of each of multiple lighting apparatuses to change, the dimming signal is sent to each of the plurality of voltage regulator IC modules, and each voltage regulator IC module independently inputs substantially the same current to the lighting apparatus connected thereto, such that the brightness of each of the multiple lighting apparatuses is substantially the same.

In the lighting apparatus driver as described above, the dimming control is isolation dimming control.

In the lighting apparatus driver as described above, the isolation dimming control is magnetic dimming control or optocoupler based dimming control.

In the lighting apparatus driver as described above, the control signal is in the form of voltage or is based on a DALI protocol.

In the lighting apparatus driver as described above, each of the voltage regulator IC modules comprises a metal oxide semiconductor field effect transistor (MOSFET).

The lighting apparatus driver as described above does not include a half bridge.

The lighting apparatus driver as described above is used to drive a plurality of LED lamps connected in parallel.

In the lighting apparatus driver as described above, the LED lamps have different sizes and/or power.

The lighting apparatus driver as described above further comprises a Boost module to boost a rectified voltage.

In the lighting apparatus driver as described above, the Boost module is coupled between the rectifier and the plurality of voltage regulator IC modules.

In the lighting apparatus driver as described above, the rectifier is a rectifier bridge.

This summary of the invention is intended to provide an overview of the subject matter described in the present disclosure. It is not intended to provide an exclusive or exhaustive explanation of the apparatuses and/or methods illustrated in the accompanying drawings and the description below. Details of one or more aspects of the present disclosure are given in the accompanying drawings and the description below.

### BRIEF DESCRIPTION OF THE DRAWINGS

The present disclosure may be better understood from the description of various embodiments of the present disclosure by referring to the drawings, and in the drawings:

FIG. 1 is an exemplary block diagram 100 of lighting apparatuses and drivers thereof in the prior art;

FIG. 2 is a more detailed circuit schematic diagram 200 of lighting apparatuses and drivers thereof in the prior art;

FIG. 3 is an exemplary block diagram 300 of lighting apparatuses and drivers thereof according to an embodiment of the present invention;

FIG. 4 is a more detailed schematic circuit diagram 400 of lighting apparatuses and drivers thereof according to an embodiment of the present invention;

FIG. 5 is an exemplary block diagram 500 of lighting apparatuses and drivers thereof according to another embodiment of the present invention;

FIG. 6 is a more detailed schematic circuit diagram 600 of lighting apparatuses and drivers thereof according to another embodiment of the present invention.

### SPECIFIC EMBODIMENTS

Unless otherwise defined, technical and scientific terms used herein shall have the same meanings as commonly understood by those of ordinary skill in the art to which the present disclosure belongs. Terms like “first”, “second”, etc., used in this application, are only intended to distinguish between different components rather than implying any sequence, quantity, or importance. Likewise, terms like “a”, “one”, etc., denote the presence of at least one rather than indicating a limitation on quantity. Terms like “comprise”, “contain”, “include”, “consist of”, etc., mean that the elements or objects preceding “comprise”, “contain”, “include”, or “consist of” cover each element or object as well as equivalents thereof following “comprise”, “contain”, “include”, or “consist of”, but do not exclude any other elements or objects. Terms like “coupled”, “connected”, etc., may include an electrical connection, be it direct or indirect rather than being limited to being physically or mechanically connected.

An embodiment is an implementation or example. Reference in the description to “an embodiment”, “one embodiment”, “some embodiments”, “various embodiments”, or “other embodiments”, means that a particular feature, configuration, or characteristic described in conjunction with embodiments is included in at least some, but not necessarily all, embodiments of the technology. Various instances of “an embodiment”, “one embodiment”, or “some embodiments”, do not necessarily all refer to the same embodiment. Elements or aspects of one embodiment may be combined with elements or aspects of another embodiment.

Not all components, features, structures, characteristics, etc., described and illustrated herein are necessarily included in a particular embodiment or a plurality of embodiments. For example, if it is stated in the description that a component, feature, structure or characteristic “can”, “may”, “could”, or “might” be included, then inclusion of that particular component, feature, structure or characteristic is not required. If one element or one element is mentioned in the description or claims, it does not mean that only one element is present. If an “additional” element is mentioned in the description or claims, it does not preclude the presence of more than one of the additional element.

It should be noted that although some embodiments have been described by referring to particular implementations, other implementations are possible according to some embodiments. In addition, the arrangement and/or sequence of circuit elements or other features shown in the drawings and/or described herein need not be set in the particular manner shown and described. Many other arrangements are possible according to some embodiments.

In each of the systems shown in the various drawings of the present disclosure, elements in some cases may each have the same reference symbols or different reference symbols indicating that the elements denoted may be different and/or similar. However, elements may be flexible enough to have different implementations and work with some or all of the systems shown or described herein. The various elements shown in the various drawings of the present disclosure may be the same or different. Which one is to be called a first element and which one is to be called a second element is discretionary.

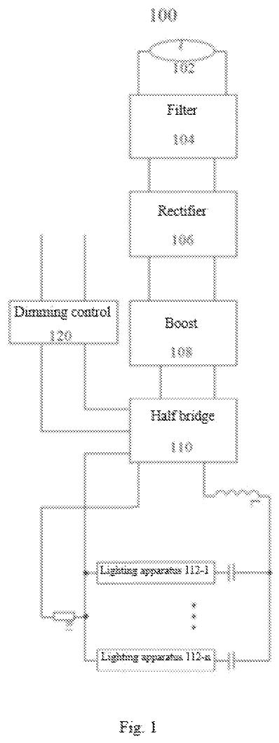

FIG. 1 is an exemplary block diagram 100 of lighting apparatuses and drivers thereof in the prior art. The circuit block diagram shown in FIG. 1 includes: a power supply 102, a filter 104, a rectifier 106, a Boost module 108, a half bridge 110, a dimming control 120, and n lighting apparatuses 112-1 to 112-n connected in parallel. The dimming control 120 may be connected to the half bridge 110 so that the half bridge 110 can adjust the current output to each lighting apparatus according to a dimming signal sent by the dimming control 120, thereby achieving dimming. A lighting apparatus is, for example, an LED lamp. In addition, the circuit further comprises some other components, such as an inductor L and a resistor R1.

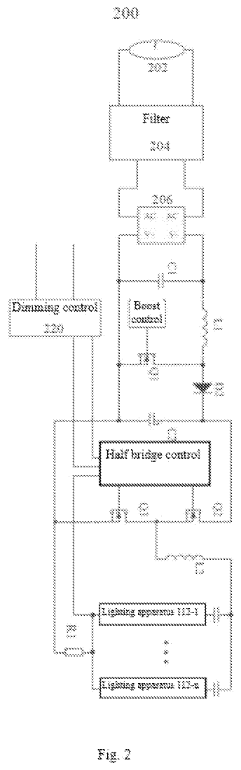

FIG. 2 is a more detailed circuit schematic diagram 200 of lighting apparatuses and drivers thereof in the prior art. In FIG. 1, the component 202 is a power supply, the component 204 is a filter, and the component 206 is a rectifier bridge, which is a concrete form of a rectifier and may be used to convert an alternating current voltage into a direct current voltage. C1 is a filter capacitor. L1 is a Boost topological inductor. The “boost control” shown in the drawing is a control integrated circuit for Boost topology. Q1 is a Boost topological switch. As an example, Q1 may be an on/off metal-oxide-semiconductor field-effect transistor (MOSFET). D2 is a Boost topological fly-wheel diode. C2 may be a capacitor used to, for example, reduce voltage ripple. The half bridge module shown in FIG. 1 comprises a “half bridge control”, and one or more topological switches Q2, Q3, which may also be an on/off metal oxide semiconductor field effect transistor (MOSFET). Multiple lighting apparatuses (for example, LEDs) 212-1 to 212-n connected in parallel are further included. Similarly, the circuit further comprises some other components, such as an inductor L2 and a resistor R2.

As mentioned above, taking FIG. 1 as an example, when the dimming control 120 sends a dimming signal to the half bridge 110, the half bridge 110 can adjust the current output to the lighting apparatuses (for example, LEDs) 112-1 to 112-n according to the dimming signal. Since the lighting apparatuses 112-1 to 112-n are connected in parallel, and due to factors such as errors in the manufacture of each lamp, the actual current flowing through each LED lamp may vary, resulting in differences in lamp brightness. This becomes even more obvious when the LED lamps are considerably dimmed. This phenomenon intensifies when these lighting apparatuses operate at low temperatures. In addition, when a load change occurs, for example, when the number of loads is reduced from n to n−1, n−2, or n−3, the current flowing through each lighting apparatus may increase. Moreover, the use of a half bridge increases the manufacturing cost of the entire circuit. These may all negatively impact user experience. There is a need for a lighting apparatus driver that enables each lighting apparatus to have substantially the same brightness when dimmed and can have further reduced costs.

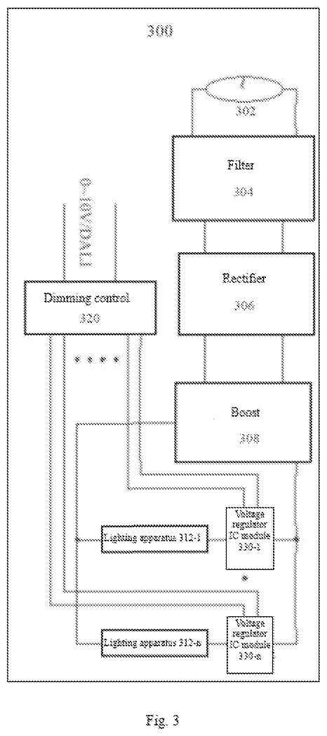

FIG. 3 is an exemplary block diagram 300 of lighting apparatuses and drivers thereof according to one embodiment of the present invention. As shown in FIG. 3, one or more of the following may be included in the circuit block diagram according to an embodiment of the present invention: a power supply 302; a filter 304, which may be used to filter out noise (for example, high-frequency noise generated by high-frequency switching) to improve one or more of the electromagnetic interference (EMI), power factor (PF), and total harmonic distortion (THD) of the circuit; a rectifier 306, which may be used to convert an alternating current voltage into a direct current voltage, wherein the rectifier 306 may be a rectifier bridge in one embodiment; a Boost module 308, which may be used to boost a rectified voltage and output a relatively constant voltage; a dimming control 320; and lighting apparatuses (for example, LED lamps) 312-1 to 312-n, which may be connected in parallel in one embodiment; in addition, one or more voltage regulator integrated circuit (IC) modules 330-1 to 330-n coupled to the Boost module 308 may be further included. In one embodiment, each of the voltage regulator integrated circuit (IC) modules 330-1 to 330-n may comprise a Buck module or a FlyBack module. Each of the voltage regulator IC modules 330-1 to 330-n may be further connected to a separate lighting apparatus (for example, one of the lighting apparatuses 312-1 to 312-n). Further, each of the voltage regulator IC modules 330-1 to 330-n may be coupled to the dimming control 320 so that the dimming control 320 may send a dimming control signal to each of the plurality of voltage regulator IC modules 330-1 to 330-n. In one non-limiting example, the Buck modules or FlyBack modules 330-1 to 330-n may be Buck modules or FlyBack modules as commonly understood and used in the art. For example, each of the Buck modules or FlyBack modules 330-1 to 330-n may be an integrated circuit module, which may comprise a metal oxide semiconductor field effect transistor (MOSFET). The integrated circuit module may further comprise one or more diodes, and a control circuit corresponding to a Buck module or a FlyBack module, as is readily comprehensible to those of ordinary skill in the art.

According to embodiments of the present invention, each of the plurality of voltage regulator IC modules 330-1 to 330-n (for example, each of the plurality of Buck modules or FlyBack modules) may, using a voltage generated via a Boost module, independently loads and controls a current input to the lighting apparatus (for example, LED) connected thereto. For example, when the dimming control 320 generates a dimming control signal and sends the dimming control signal to each of the plurality of voltage regulator IC modules 330-1 to 330-n (for example, each of the plurality of Buck modules or FlyBack modules), each of the voltage regulator IC modules 330-1 to 330-n can independently input substantially the same current to the lighting apparatus connected thereto so that the brightness of each lighting apparatus is substantially the same. With such a circuit designed according to the present invention, when the lighting load is reduced, for example, when the number of loads is reduced from n to n−1, n−2, or n−3, this independent control mechanism ensures that substantially the same current is still used for each operating lighting apparatus, so that the brightness of the lighting apparatuses remains substantially the same, without being affected by a change in the number of loads. In the present invention, substantially the same current and substantially the same brightness may be interpreted to mean that changes of the current or of the brightness within a certain range are imperceptible to most users, thereby improving user experience.

In one embodiment, a dimming control signal transmitted to the dimming control 320 may be in the form of voltage or may be based on a DALI protocol. As a non-limiting example, a voltage may be in the range of 0-10 V. In one embodiment, the dimming control 320 may be isolation dimming control that isolates a dimming control signal from the main topologies (for example, Boost topology, Buck topology, and FlyBack topology). Isolation may take the form of magnetic dimming control or optocoupler based dimming control.

As described above, a lighting apparatus driver according to an embodiment of the present invention may include no half bridges, and thus the circuit manufacturing costs may be reduced. The Buck and FlyBack modules proposed in the present invention use well-established integrated circuits, which results in further reductions in circuit manufacturing costs. Further, these lighting apparatuses (for example, LEDs) may have different sizes and/or power. Since a separate voltage regulator IC module is used to control the current used for each lighting apparatus, the brightness of each lighting apparatus may be kept substantially the same even if each lighting apparatus has a different size and/or power, as long as the applied electrical parameters are within the rated ranges of the lighting apparatuses. Further, even when each lighting apparatus is considerably dimmed, the brightness of each lighting apparatus can remain substantially the same.

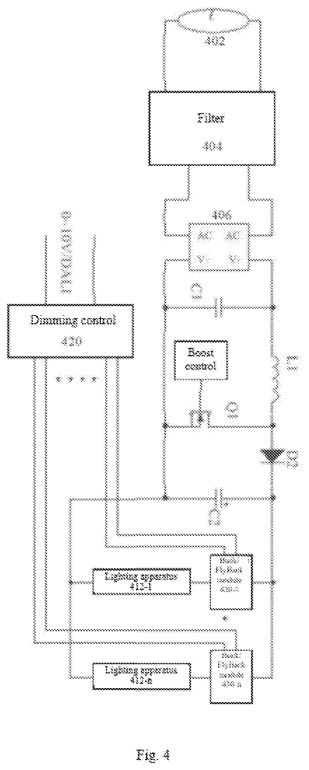

FIG. 4 is a more detailed schematic circuit diagram 400 of lighting apparatuses and drivers thereof according to an embodiment of the present invention. The components shown in FIG. 4 that are the same as those shown in FIG. 3 will not be described again herein. In FIG. 4, the component 402 is a power supply, the component 404 is a filter, and the component 406 is a rectifier bridge, which is a concrete form of a rectifier and may be used to convert an alternating current voltage into a direct current voltage. C1 is a filter capacitor. L1 is a Boost topological inductor. The “boost control” shown in the drawing is a control integrated circuit for Boost topology. Q1 is a Boost topological switch. As an example, Q1 may be an on/off metal oxide semiconductor field effect transistor (MOSFET). D2 is a Boost topological fly wheel diode. C2 may be an electrolytic capacitor for reducing voltage ripples. As mentioned above, the circuit shown in FIG. 4 further comprises a plurality of voltage regulator IC modules, such as a plurality of Buck modules 430-1 to 430-n or a plurality of FlyBack modules 430-1 to 430-n, each of which is used to independently control a current input to the lighting apparatus (one of 412-1 to 412-n) connected thereto. Further, a dimming control 420 is further included, which is connected to each of a plurality of Buck modules or FlyBack modules 430-1 to 430-n.

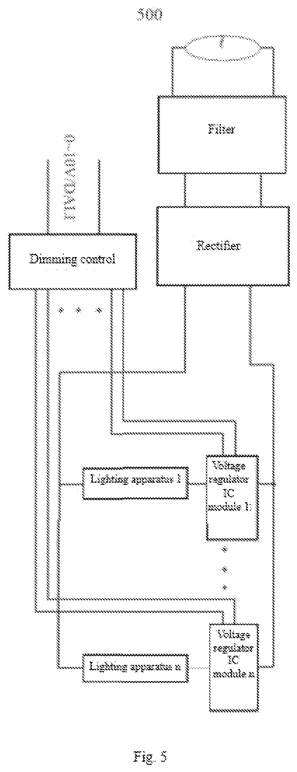

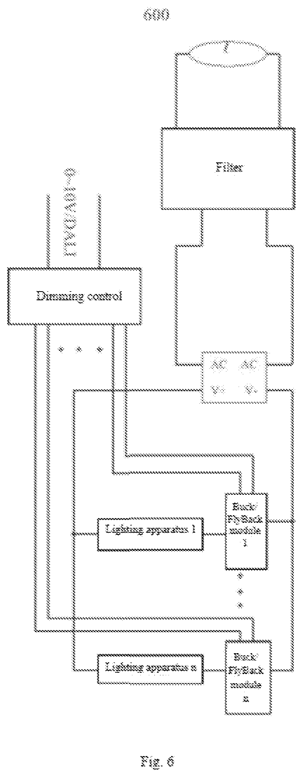

FIG. 5 is an exemplary block diagram 500 of lighting apparatuses and drivers thereof according to another embodiment of the present invention, and FIG. 6 is a more detailed circuit schematic diagram 600 of lighting apparatuses and drivers thereof according to another embodiment of the present invention. The circuit block diagram shown in FIG. 5 is substantially the same as the circuit block diagram shown in FIG. 3, except that FIG. 5 may include no Boost topological modules. Similarly, the schematic circuit diagram shown in FIG. 6 is substantially the same as the schematic circuit diagrams shown in FIG. 4, except that FIG. 6 may include no Boost topological modules. Corresponding identical or similar components will not be described again herein. Thus, the circuits as shown in FIG. 5 and FIG. 6 may also be used to control the brightness of each lighting apparatus such that it remains substantially the same.

While LEDs are mainly used to illustrate the circuit structure in the description of the present invention, LEDs represent only one of various types of lighting apparatuses that may be used for the design concept defined by the present invention. Therefore, other lighting apparatuses may also be used, and use of LEDs is only exemplary, rather than being construed as limiting the present invention.

The present technology is not limited to the specific details set forth herein. In fact, those of ordinary skill in the art benefiting from the present disclosure will appreciate that many other modifications derived from the foregoing descriptions and drawings may be made within the scope of the present technology. Therefore, it is the appended claims including any amendments thereto that define the scope of the present technology.

What is claimed is:

1. A lighting apparatus driver, comprising:
a filter to filter out noise;
a rectifier to convert an AC voltage into a DC voltage;
a plurality of voltage regulator IC modules connected to the rectifier directly or indirectly, wherein each of the plurality of voltage regulator IC modules is to be connected to a separate lighting apparatus, such that each of the plurality of voltage regulator IC modules is capable of independently controlling current input to the lighting apparatus connected thereto.

2. The lighting apparatus driver according to claim 1, wherein the plurality of voltage regulator IC modules are Buck modules or FlyBack modules.

3. The lighting apparatus driver according to claim 1, wherein the lighting apparatus driver further comprises a dimming control, and the dimming control is coupled to each of the plurality of voltage regulator IC modules, so as to send a dimming control signal to each of the plurality of voltage regulator IC modules.

4. The lighting apparatus driver according to claim 3, wherein when the dimming control signal is to cause brightness of each of multiple lighting apparatuses to change, the dimming signal is sent to each of the plurality of voltage regulator IC modules, and each voltage regulator IC module independently inputs substantially the same current to the lighting apparatus connected thereto, such that the brightness of each of the multiple lighting apparatus is substantially the same.

5. The lighting apparatus driver according to claim 3, wherein the dimming control is isolation dimming control.

6. The lighting apparatus driver according to claim 5, wherein the isolation dimming control is magnetic dimming control or optocoupler based dimming control.

7. The lighting apparatus driver according to claim 3, wherein the control signal is in a form of voltage or is based on a DALI protocol.

8. The lighting apparatus driver according to claim 1, wherein each of the voltage regulator IC modules comprises a metal oxide semiconductor field effect transistor (MOSFET).

9. The lighting apparatus driver according to claim 1, wherein the lighting apparatus driver does not include a half bridge.

10. The lighting apparatus driver according to claim 1, wherein the lighting apparatus driver is to drive a plurality of LED lamps connected in parallel.

11. The lighting apparatus driver according to claim 10, wherein the LED lamps have different sizes and/or power.

12. The lighting apparatus driver according to claim 1, further comprising a Boost module to boost a rectified voltage.

13. The lighting apparatus driver according to claim 12, wherein the Boost module is coupled between the rectifier and the plurality of voltage regulator IC modules.

14. The lighting apparatus driver according to claim 1, wherein the rectifier is a rectifier bridge.
